(19) United States
(12) Patent Application Publication
(10) Pub. No.: US 2017/0197454 A1
(43) Pub. Date: Jul. 13, 2017

(54) TIPS

(71) Applicant: John Vernan Rasanen, West Boothbay Harbor, ME (US)

(72) Inventor: John Vernan Rasanen, West Boothbay Harbor, ME (US)

(21) Appl. No.: 15/390,897

(22) Filed: Dec. 27, 2016

Related U.S. Application Data
(60) Provisional application No. 62/277,524, filed on Jan. 12, 2016.

(51) Int. Cl. B43K 23/012; F16M 13/04

(52) U.S. Cl. CPC B43K 23/012; F16M 13/04

(57) ABSTRACT

A molded sleeve fitting over a finger containing an integral instrument threaded cylinder to allow a single finger to manipulate a tool whereas it has commonly been the task of a total hand, wrist, and forearm effort

### CROSS-REFERENCE TO RELATED APPLICATIONS

Provisional Patent application No. 62/277,524

Invention name; Tips

Inventor; John Rasanen

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF INVENTION

Hand manipulation of an instrument has historically been driven by the need of force to make a mark. Hence the ancient practice of full hand/forearm/shoulder involvement in this task. Hand/wrist/forearm fatigue, poor coordination, physical ailments all conspire to make this task difficult. The embodiment of new art in this process is the ease of use, i.e. picking up a marking device, simple manipulation of a device in relation to the surface to be marked, the holding of an eating utensil, or the simple use of a finger tap in regards to keyboard devices.

Prior art in Publication No.: U.S. 2005/0062730 A1; U.S. 2012/0170962A1, and Patents No.: U.S. Pat. No. 6,905,271,B1; U.S. Pat. No. 6,249,277 B1; U.S. Pat. No. 5,868,509 all make use of the following of which new art is embodied in the TIPS invention.

Patents U.S. Pat. No. 6,905,271,B1; U.S. Pat. No. 6,249,277 B1A; U.S. Pat. No. 5,868,509 all embody a mechanical manipulation needed to secure a device to the finger through a Velcro type strapping system or the involvement of another digit to maintain a secure fits This approach creates a complication in ease of use and the inherent difficulty of mechanical fastening stability

Patents U.S. 2005/0062730 A1, U.S. Pat. No. 6,249,277 B1A, the location of the device on the finger results in inherent stability concerns due to either the location on the digit, or the limited scope of the attachment area.

Patents U.S. Pat. Nos. 6,905,271,B1, U.S. 2005/0062730 A1 make use of a mechanical means to secure an instrument in a device creates numerous issues with ease of use, this being the difficulty of adjustment of the tool, limitations on sizing of a tool to at the device, the necessity of purchasing a specifically designed tool, and the inherent issues of maintaining the accuracy and function of a mechanical device.

### BRIEF SUMMARY OF THE INVENTION

TIPS is an easy to use device that slips effortlessly of the index finger secured by material elasticity, location on the finger and a contour matching finger physiology. The innovative top device cylinder has a unique spiral threading which allows for tool adjustment by a simple twist of the marking tool.

When the finger is inserted in the device the motion of manipulation becomes a simple movement of the index finger, eliminating the hand/forearm/shoulder involvements making the motion simpler and less physically stressful to the person. The device may be used for and the cylindrical instrument holder configured for various instrument manipulations currently done by the hand

### BRIEF DESCRIPTION OF THE SEVERAL VIEWS OF THE DRAWING

FIG. 1. shows an angled view presenting the various embodiments of the invention

FIG. 2. is a side view conveying the location of the device on a finger and the typical application of a marking device as embodied in the invention

FIG. 3, portrays the embodiment of the slanted breathing slots of the invention and the invention logo

FIG. 4. is an internal view of both the finger sleeve and the device holder

### DETAILED DESCRIPTION OF THE INVENTION

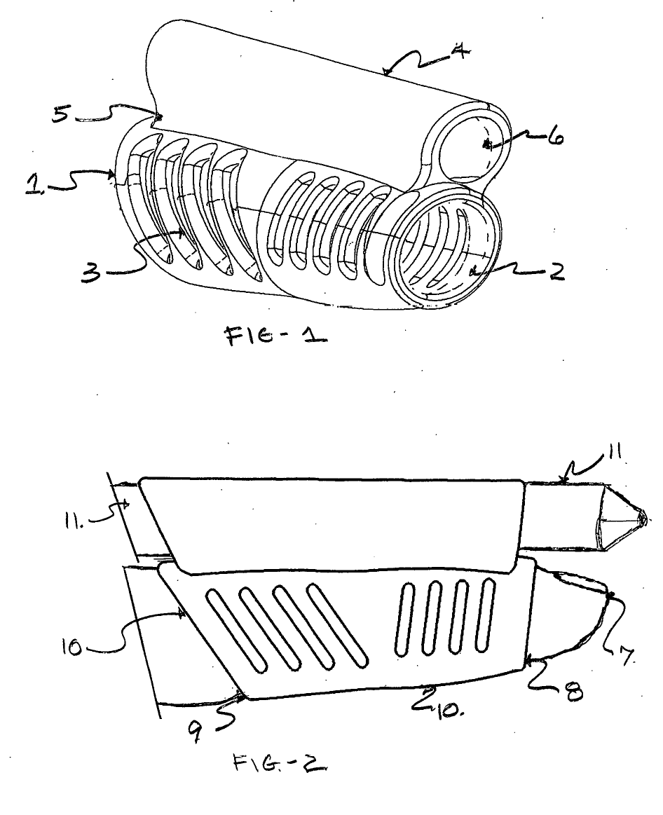

FIG. 1. 1) Depicts a slightly angled view of the embodied art showing the larger back portion of the finger hold through which a finger is inserted. 2) Is the further end of the device through which the fingertip will protrude. 3) Depicts the series of open ventilation slots to provide heat and moisture relief to the finger along with enabling a flexibility in attachment to the finger. 4) Depicts the integral tool/device holder portion of the invention through which a marking device/tool is inserted through either end. With an elasticity as the finger portion of the invention the tool/device cylinder will accept a variety of device diameters. 5) This view depicts the moulder intersection of the two invention cylinders increasing stability of a device/tool to allow the actions of a tool/device to accurately mimic the motions of the finger. 6) Embodied in the invention is a unique threading of the device holder the allows for increased stability of the tool and through a simple twisting motion of the tool allows it to be accurately adjusted for depth to the surface to be masked.

FIG. 2. 7) This detail portrays the finger location and placement the finger sleeve in relation to the fingertip, first and second knuckles. 8) This shows the typical location on the underside curvature of the fingertip and knuckle crease where the sleeve is worn. 9) Depicts the underside curvature of the finger past the second knuckle crease which is the fitted location of the holder. 9) Embodied in the invention is a molded curvature mimicking the finger to allow a secure fit to the finger. 10) Portrays the embodied curvature matching the fingertip profile that serves as the front end secure fit allowing the actual fingertip to be exposed and not enclosed in the sleeve. 11) Depicts a typical marking instrument as inserted into the upper cylinder.

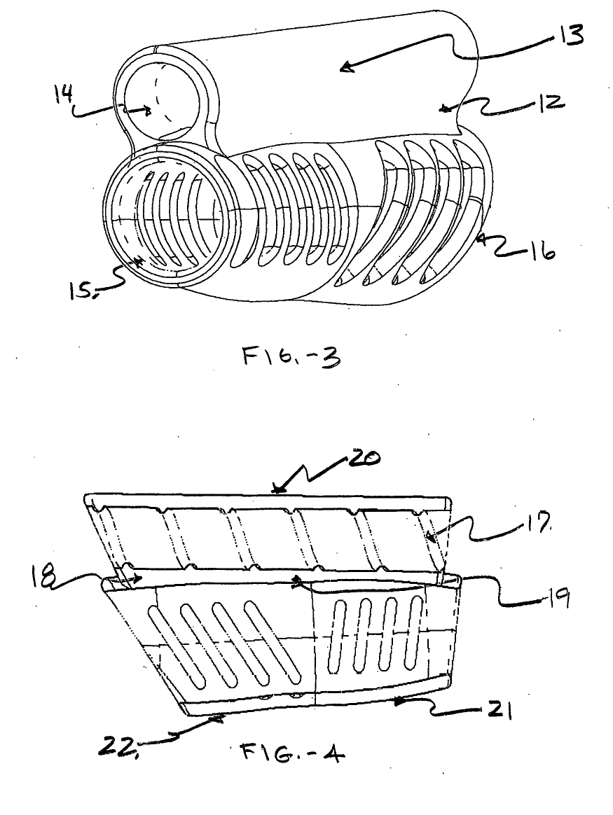

FIG. 3. 12) Portrays the slightly curved and elevated base of the tool/device cylinder. It is an integral part of the whole. 13) Located on each side of the device/tool holders the embossed invention name. 14) Shows the internal wall of the tool/device holder as cylindrical and surfaced with a powdered application for ease. 15) Shows the fingertip end internal wall of the finger sleeve as a modified cylinder to match to general physiology of the finger and with a powdered application for ease of finger insertion. 16) Depicts the finger insertion end of the device.

FIG. 4. 17) Embodied in this invention is a unique threading configuration designed for a twofold purpose. Allowing a secure and stable tool/marking device will at the same time through a twisting motion allowing the internal threading to accurately arrive at the preferred depth setting. 18) Depicts the previously mentioned slight tilt embodied in TIPS that creates a slight angle of the inserted tool/device. 19) Mimicking the slight curvature of the finger top the invention embodies a design to reflect physiology. 20) Portrays an embodied top rib in the device holder for stability to react to a downward movement of pressure on the device/tool. 21) Another view of the ergonomic design embodied in the finger sleeve portion of the invention. 22) Another view of the ergonomic design embodied in the finger sleeve portion of the invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. TIPS embodies new art in regards to the actual process of attaching a instrument holder to the finger. The one-piece nature of the sleeve and lack of mechanical manipulation results in a simple slide on application, while at the same time increasing stability of the chosen instrument and a secure fit on the finger

2. TIPS embodies an innovative spiral threading of the instrument cylinder which results in instrument stability and a simple twisting motion for accurate and secure instrument positioning.

3. TIPS embodies a new capability for manipulation of finger/hand held tools resulting ergonomic simplicity for all applications
